(19) United States
(12) Patent Application Publication
(10) Pub. No.: US 2023/0001471 A1
(43) Pub. Date: Jan. 5, 2023

(54) RAPID MANUFACTURING PROCESS FOR HIGH DEFINITION CERAMIC CORE USED FOR INVESTMENT CASTING APPLICATIONS

(71) Applicants: Siemens Energy Global GmbH & Co. KG, München (DE); Mikro Systems, Inc., Charlottesville, VA (US)

(72) Inventors: Gary B. Merrill, Orlando, FL (US); Roy Eakins, Madison, VA (US)

(21) Appl. No.: 17/779,162

(22) PCT Filed: Jan. 13, 2020
(86) PCT No.: PCT/US2020/013287

§ 371 Date: May 24, 2022

(51) Int. Cl. B22C 9/10; B33Y 80/00

(52) U.S. Cl. CPC B22C 9/10; B33Y 80/00

(57) ABSTRACT

A method for producing a flexible mold for casting a ceramic core, the ceramic core used for an investment casting, is presented. The method includes forming a consumable master tool by 3D-printing, producing the flexible mold from the master tool, allowing the flexible mold to cure, and removing the consumable master tool. The master tool includes a negative surface geometry representative of the flexible mold to be produced.

### BACKGROUND

Aspects of the disclosure generally relate to investment casting processes. More specifically, a method for producing a flexible mold for casting a ceramic core is presented. Additionally, a method for forming a ceramic core used for an investment casting from the flexible mold is also presented.

Currently, investment casting is commonly used to produce gas turbine components such as blades and vanes having complex airfoil shapes and internal cooling passage geometries. The production of an investment cast gas turbine blade or vane involves producing a ceramic casting mold having an outer ceramic shell with an inside surface corresponding to the airfoil shape and one or more ceramic cores positioned within the outer ceramic shell, corresponding to interior cooling passages to be formed within the airfoil. Molten alloy is introduced into the ceramic casting mold and is then allowed to cool and to harden. The outer ceramic shell and ceramic core(s) are then removed by chemical or mechanical means to reveal the cast blade or vane having the external airfoil shape and hollow interior cooling passages in the shape of the ceramic core(s).

### BRIEF SUMMARY

Briefly described, aspects of the present disclosure relate to a method for producing a flexible mold for casting a ceramic core and a method of forming a ceramic core for an investment casting from a flexible mold.

A first aspect provides a method for producing a flexible mold for casting a ceramic core. The method includes the steps of forming a consumable master tool by 3D-printing, the master tool having a negative surface geometry representative of the flexible mold to be produced, producing the flexible mold from the master tool, allowing the flexible mold to cure, and removing the consumable master tool.

A second aspect provides a method of forming a ceramic core for an investment casting from a flexible mold. The method includes the steps of forming a consumable master tool by 3D-printing, the master tool having a negative surface geometry representative of the flexible mold to be produced, producing the flexible mold from the master tool, allowing the flexible mold to cure, removing the consumable master tool, filling a mold cavity defined by a containment vessel containing the flexible mold within the mold cavity, with a ceramic slurry, and removing the cured ceramic core from the flexible mold.

### BRIEF DESCRIPTION OF THE DRAWINGS

To easily identify the discussion of any particular element or act, the most significant digit or digits in a reference number refer to the figure number in which that element is first introduced.

FIG. 1 illustrates a routine for producing a flexible mold for casting a ceramic core.

FIG. 2 illustrates a simplified pictorial view of the first three steps of the proposed method.

FIG. 3 illustrates simplified pictorial view of the last three steps of the proposed method.

### DETAILED DESCRIPTION

In contrast to the currently used method of forming a ceramic core as described above, ceramic cores may eventually be produced utilizing additive manufacturing processes (Three-dimensional (3D) printing). 3D printed ceramic cores are showing potential that can result in substantially reduced time to manufacture which would eliminate the time needed for tool design and manufacture. However, this technology is currently limited by the resolution and core composition.

Briefly, a method for producing a flexible mold for casting a ceramic core is presented. From the flexible mold, a ceramic core for an investment casting may be produced. For the purposes of this disclosure, the term ‘flexible’ as used herein, refers to a quick curable material such as a room temperature vulcanizing (RTV) silicone rubber or other material which may be used to form the flexible mold which is not rigid like prior art metal molds, but that allows the mold to be bent and stretched to a degree in order to facilitate removal of the mold from a structure cast therein.

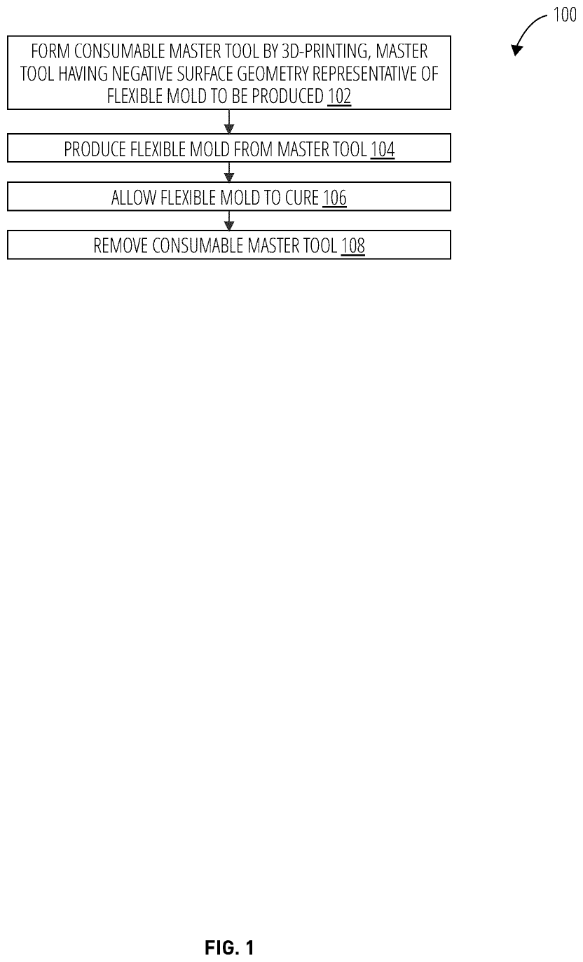

Referring now to FIG. 1, a flowchart depicting a method for producing a flexible mold is shown. In step 102, routine 100 forms a consumable master tool by 3D-printing, the master tool having a negative surface geometry representative of the flexible mold to be produced. In step 104, routine 100 produces the flexible mold from the master tool. In step 106, routine 100 allows the flexible mold to cure. In step 108, routine 100 removes the consumable master tool.

In an embodiment, the consumable master tool is 3D printed from a printable wax. Development work has shown that printed wax may be effectively used as a master tool within a mold cavity to produce a flexible mold with integrity. In an embodiment, the master tool may be a multi-sided three-dimensional (3D) master tool in order to produce ceramic cores with intricate geometry and/or advanced features. When the ceramic core is used in an investment casting process to produce a final component, this intricate geometry and/or advanced features will be cast into the final component. In one such example, the 3D master tool includes a surface geometry corresponding to a turbine blade or vane. Advanced features on a turbine blade or vane, for example, may include detailed features such as trailing edge cooling holes.

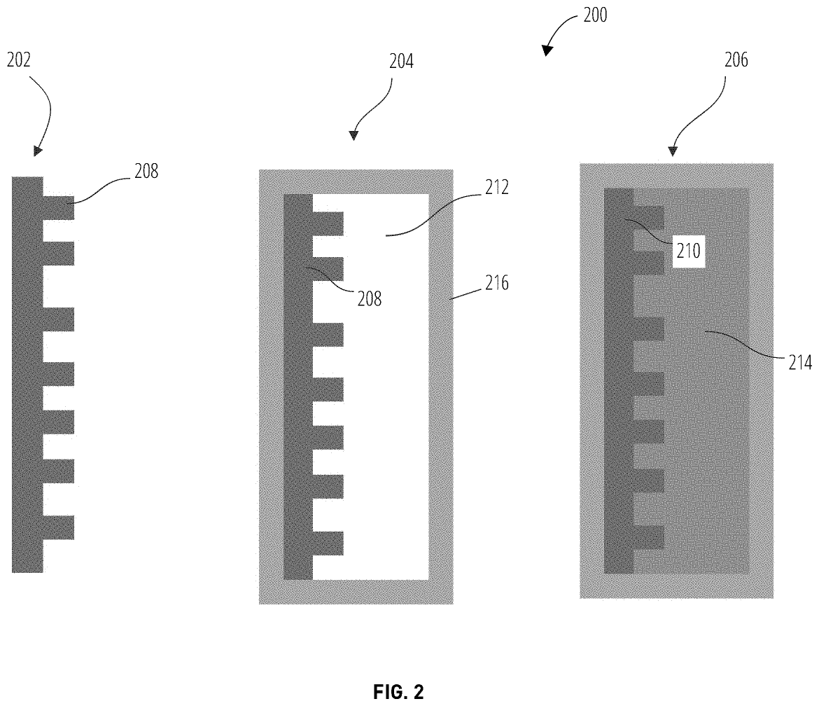

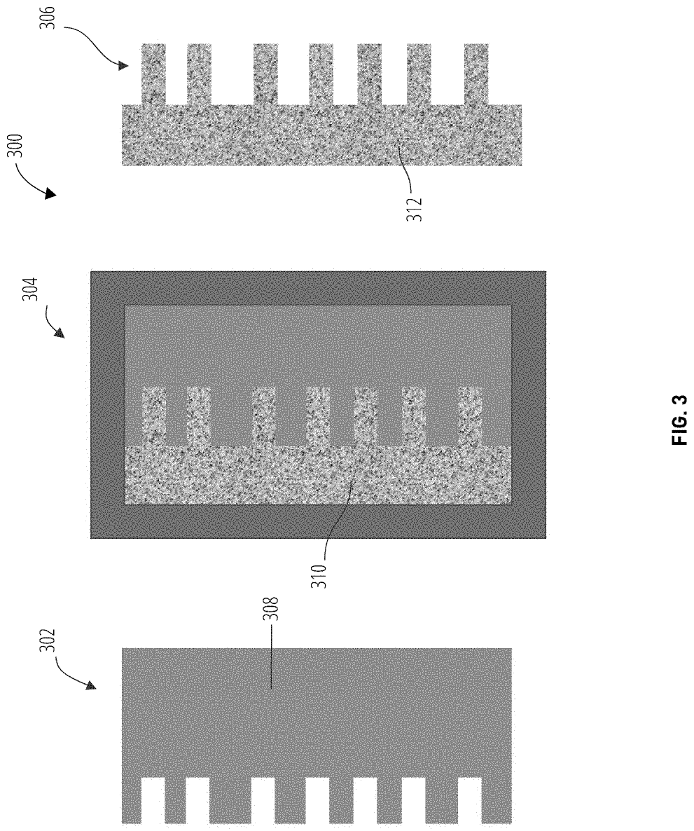

FIGS. 2 and 3 illustrate an embodiment of the proposed method to produce a flexible mold for casting a ceramic core. Referring now to FIG. 2, the first three steps 200 of an embodiment of the proposed method are shown. In step 202, a 3D printed consumable wax master tool 208 is formed. For exemplary purposes, FIG. 2 depicts a simplified 2D representation of a 3D printed wax master tool 208 having a negative surface geometry representative of the flexible mold to be produced. The wax master tool 208 may be 3D printed using known 3D printing methods. A CAD file depicting the 3D geometry of the component to be produced may be utilized by the 3D printer to produce the printed consumable wax master tool 208. It has been shown that 3D printed wax technology is the most dimensionally stable of the printed processes to date.

The printed consumable wax master tool 208 may be an insert for creating a surface in a flexible mold. Inserts may be utilized to further define a section of the geometry of the existing flexible mold surface. The inserts may include a bottom surface, side surface, and a top surface whose geometry includes a finer resolution or otherwise higher definition than the adjacent geometry of the existing flexible mold. The insert may be installed in correspondingly shaped cavities within the existing flexible mold and may be interchanged with other inserts in order to create alternate topography on the ceramic core.

In another embodiment, the produced ceramic core may be a ceramic core insert inserted into a surface of a ceramic shell. The ceramic core insert may include a contoured geometry on a surface having fine details. The ceramic core insert may also include interlocking features on another surface intended to hold the ceramic core insert in place effectively to the ceramic shell after a shell dipping process. The attachment of ceramic core insert to the ceramic shell allows the core insert surface to become part of the ceramic shell. This contoured geometry may then be cast into a component.

In step 204, the wax master tool 208 is placed in mold cavity 210. A containment vessel 214 having mold cavity 210 may be obtained for containing the master tool 208 as well as a liquid mold material 212 for producing the flexible mold. The master tool 208 may be appropriately supported within the mold cavity 210. While other shaped containment vessels may be utilized in the presented method, for ease of use, a box shaped containment vessel 214 is exemplified in the shown embodiment. Mold cavity 210 is configured to receive a flexible liquid mold material 212. The flexible liquid mold material 212 may be a quick curable chemical compound such as silicone rubber. By situating the master tool 208 in the mold cavity 210 through suspension or another suitable means, the mold cavity 210 may be filled with the liquid mold material 212, in a fluid state that will conform to the surface topography of the master tool 208.

In step 206, the liquid mold material 212 may be poured into the mold cavity 210 until it is filled or partially filled and the master tool 208 is encapsulated by the liquid mold material 212 on the surfaces whose geometry is intended to be imparted in the flexible mold formed upon the curing of the liquid mold material 212. The chemical compound is then allowed, step 106, to cure, generally, by some thermodynamic and/or chemical process familiar to those skilled in the art.

Referring now to FIG. 3, the last three steps 300 of the proposed method are illustrated. Upon curing, the now solidified flexible mold 308 will yield a flexible mold capable of casting the external geometry of a ceramic core. In an embodiment, removing 108, 302 the master tool 208 from the flexible mold 308 includes dissolving the printable wax. Alternately, the printable wax may be melted through heating means. In an embodiment, the master tool 208 is a two-sided master tool such that the geometry on each of the two sides may create two separate flexible opposing mold halves. The two-sided master tool 208 may have a similar geometry on each of the two sides or completely different geometry on each of the two sides.

With the flexible mold 308 now produced (or inserted within an existing flexible mold), a ceramic core 312 may then be cast from the flexible mold 308. In step 304, a ceramic slurry is poured into the mold cavity 210. In the embodiment where two separate opposing halves of a flexible mold 308 were created, the two separate opposing mold halves may be aligned to form a cavity capable of receiving the ceramic slurry 310. The ceramic slurry 310 may be a liquid mixture including silica dioxide and solvent or other mixture familiar to those of skill in the art. The flexible mold 308 may be supported in an appropriate structure that may be the original containment vessel 214, but also may be another suitable structure that can support the flexible mold 308 as well as the ceramic slurry 310. The ceramic slurry 310 is allowed to cure generally by some thermodynamic and/or chemical process familiar to those skilled in the art. The flexible mold 308 may then be separated from the cured ceramic core 312, thereby exposing the newly molded ceramic core 312, itself in a ‘green’ state. The ‘green’ ceramic core 312 may then be subject to an industrial process know to those skilled in the art such as, for example, hand-detailing and kiln-firing and/or sintering. The ceramic core 312 is thus produced as shown by illustrated step 306 in FIG. 3. The ceramic core thus produced is suitable for use in a conventional metal alloy casting process.

Those skilled in the art will be aware that the current methods employed to yield the geometry definition of the flexible mold topography is dependent on a machined master tool, conventionally cut or otherwise sculpted from a solid block of a raw metal such as aluminum. Such master tooling requires an extraordinary amount of time labor, and cost to produce and has limited flexibility in terms of the ability to implement alterations, repairs, or rework, without considerably impacting a typical budget and labor schedule. The methods disclosed reduce design time and eliminate the need to manufacture metal master tooling.

While specific embodiments have been described in detail, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

What is claimed is:

1. A method 200 for producing a flexible mold 308 for casting a ceramic core 312, comprising:
forming 102 a consumable master tool 208 by 3D-printing, the master tool 208 having a negative surface geometry representative of the flexible mold to be produced;
producing 104 the flexible mold from the master tool 208;
allowing 106 the flexible mold to cure; and
removing 108 the consumable master tool from the flexible mold.

2. The method of claim 1, wherein the consumable master tool 208 is a printable wax.

3. The method of claim 1, wherein the producing step includes:
disposing the consumable master tool 208 into a mold cavity 210, and
filling 206 the mold cavity 210 with a liquid mold material 212 so that the master tool 208 is encapsulated by the liquid mold material 212 on the surfaces whose geometry is to be produced.

4. The method of claim 3, wherein the liquid mold material 212 is uncured silicone rubber.

5. The method of claim 1, wherein the removing 108 includes dissolving the printable wax.

6. The method of claim 1, wherein the removing 108 includes melting the printable wax.

7. The method of claim 1, wherein the master tool 208 is a two-sided master tool such that the geometry on each of the two sides creates two separate flexible opposing mold halves.

8. The method of claim 7, wherein the producing 104 includes aligning and supporting the opposing mold halves so that the geometry imparted to a ceramic core 312 includes the geometry on at least two sides.

9. The method of claim 1, wherein the master tool 208 includes features representative of a gas turbine blade or vane.

10. A method 200, 300 of forming a ceramic core for an investment casting from a flexible mold 308, comprising:
forming 102 a consumable master tool 208 by 3D-printing, the master tool 208 having a negative surface geometry representative of the flexible mold 308 to be produced;
producing 104 the flexible mold 308 from the master tool 208;
allowing 106 the flexible mold 308 to cure;
removing 108 the consumable master tool 208 from the flexible mold 308;
filling 206 a mold cavity 210 with a ceramic slurry 310 in order to produce a ceramic core 312; and
removing 306 the cured ceramic core 312 from the flexible mold 308 once the ceramic core 312 solidifies.

11. The method of claim 10, wherein the consumable master tool is a printable wax.

12. The method of claim 10, wherein removing the consumable master tool includes dissolving the printable wax.

13. The method of claim 10, wherein removing the consumable master tool includes melting the printable wax.

14. The method of claim 10, wherein the ceramic core 312 is a ceramic core insert comprising a contoured surface geometry attached to a ceramic shell so that the contoured surface geometry becomes a contoured surface geometry of the ceramic shell.

15. The method of claim 10, wherein the mold cavity 210 is defined by a containment vessel 214 and the flexible mold 308, the containment vessel 214 containing the flexible mold 308 within the mold cavity 210.

16. The method of claim 10, wherein the master tool 208 is a two-sided master tool such that the geometry on each of the two sides creates two separate flexible opposing mold halves.

17. The method of claim 16, wherein the mold cavity is defined by the two flexible opposing mold halves.
